(19) United States
(12) Patent Application Publication
(10) Pub. No.: US 2012/0023015 A1
(43) Pub. Date: Jan. 26, 2012

(54) Consolidated Payment and Bank Error Correction

(76) Inventors: Aji Mathai, Santa Clara, CA (US); Amy Shih, San Francisco, CA (US); Eric John Gray, Sunnyvale, CA (US); Sean K. Smith, San Francisco, CA (US); John Baily, Portola Valley, CA (US); Aloke Bhatnagar, Campbell, CA (US); Ricardo D. Cortes, Los Gatos, CA (US)

(21) Appl. No.: 12/841,082

(22) Filed: Jul. 21, 2010

(51) Int. Cl. G06Q 40/00

(52) U.S. Cl. 705/40

(57) ABSTRACT

Improved techniques are disclosed for payment of accrued moneys via a third party intermediary. In one embodiment, a consolidated royalty can be provided for online sales of digital assets of a digital asset provider. Since the online sales can be from various different countries, the online sales can be in a plurality of different currencies. The royalties due a digital asset provider from online sales in the different currencies can be consolidated at appropriate times into a single currency and then disbursed to the digital asset provider. In another embodiment, royalty disbursement management can be provided to alert a digital asset provider that an attempted distribution has failed and to facilitate the digital asset provider in correcting appropriate banking information to assist in obviating the distribution failure.

### BACKGROUND OF THE INVENTION

Online media stores, such as iTunes™ Store, allow customers (i.e., online users) to purchase or rent media items, such as music or videos, or other digital assets, such as applications (software applications) over the Internet. Often, at online stores that distribute media or applications, numerous media or application items are made available and may be provided by various different content providers (e.g., music labels or movie companies) or different software providers (e.g., software companies or developers). Software tools, such as iTunes Producer™ and iTunes Connect™ available from Apple Inc. of Cupertino, Calif., can assist content or application providers with online submission of media content or applications to the iTunes™ Store.

Some online stores provide content or application providers with royalty payments on sales at the online stores. Initially, the payment of royalty payments was done with a physical check. More recently, these payments have been able to be done electronically, such as by wire transfer. However, electronic funds transfers can be relatively expensive, particularly if the distribution amount is low. Another difficulty is that royalties on sales in various different countries likely means that royalties in different currencies are likely due. Moreover, electronic payments will fail if the financial payment information is not maintained in an accurate manner.

Thus, there is a need for improved approaches to process and manage electronic payments for sales at online stores.

### SUMMARY OF THE INVENTION

Improved techniques are disclosed for payment of accrued moneys via a third party intermediary. In one embodiment, a consolidated royalty can be provided for online sales of digital assets of a digital asset provider. Since the online sales can be from various different countries, the online sales can be in a plurality of different currencies. The royalties due a digital asset provider from online sales in the different currencies can be consolidated at appropriate times into a single currency and then disbursed to the digital asset provider. In another embodiment, royalty disbursement management can be provided to alert a digital asset provider that an attempted distribution has failed and to facilitate the digital asset provider in correcting appropriate banking information to assist in obviating the distribution failure.

The invention can be implemented in numerous ways, including as a method, system, device, apparatus (including graphical user interface), or computer readable medium. Several embodiments of the invention are discussed below.

As a computer implemented method for controlling services of an online store, one embodiment can, for example, include at least the acts of generating royalties currently due to a digital asset provider for online store sales in a plurality of different currencies, initiating consolidation of the royalties currently due to the digital asset provider into a consolidated payment in a single currency, and thereafter initiating disbursement of the consolidated payment.

As a computer readable medium including at least computer program code stored thereon for providing a consolidated royalty for sales of digital assets via at least one online store, one embodiment can, for example, include at least computer program code for generating royalties currently due to a digital asset provider for online store sales in a plurality of different currencies, computer program code for initiating consolidation of the royalties currently due to the digital asset provider into a consolidated payment in a single currency, and computer program code for initiating disbursement of the consolidated payment.

As a computer implemented method, another embodiment can, for example, include at least the acts of generating royalties currently due to a digital asset provider, transmitting to the digital asset provider a report of a return of failed disbursement, and authorizing the digital asset provider to correct at least one record of incorrect banking information, which is at least one cause of the failed disbursement.

As a method for facilitating royalty disbursement, another embodiment can, for example, include at least generating amounts payable to a payee, the amounts payable in different currencies, and transmitting the amounts payable to an intermediary. The amounts payable can be converted to one or more predetermined currencies and paid to the payee. The embodiment can also include receiving from the intermediary a transaction record indicating the converted amount and an associated exchange rate; and providing a report to the payee of the converted amount paid and associated exchange rate.

As a digital asset submission and distribution system for providing a consolidated royalty for online store sales, one embodiment includes at least a digital asset storage for storing digital assets submitted to the system by digital asset providers, an online store server for coordinating distribution of the digital assets and collection of royalties currently due to a digital asset provider for online store sales in a plurality of different currencies, and a payment consolidation processor. The payment consolidation processor can initiate consolidation of the royalties currently due to the digital asset provider in the plurality of different currencies into a consolidated payment in a single currency, and initiate disbursement of the consolidated payment.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a digital asset submission and distribution system, according to one embodiment.

FIG. 2 is a flow diagram of a process for controlling services of an online store, according to one embodiment.

FIG. 3 is a flow diagram of another process, according to one embodiment.

FIG. 4 is a flow diagram of another process, according to another embodiment.

FIGS. 5-7 show exemplary report displays according to one embodiment.

### DETAILED DESCRIPTION OF CERTAIN EMBODIMENTS

Improved techniques are disclosed for payment of accrued moneys via a third party intermediary. In one embodiment, a consolidated royalty can be provided for online sales of digital assets of a digital asset provider. Since the online sales can be from various different countries, the online sales can be in a plurality of different currencies. The royalties due a digital asset provider from online sales in the different currencies can be consolidated at appropriate times into a single currency and then disbursed to the digital asset provider. In another embodiment, royalty disbursement management can be provided to alert a digital asset provider that an attempted distribution has failed and to facilitate the digital asset provider in correcting appropriate banking information to assist in obviating the distribution failure.

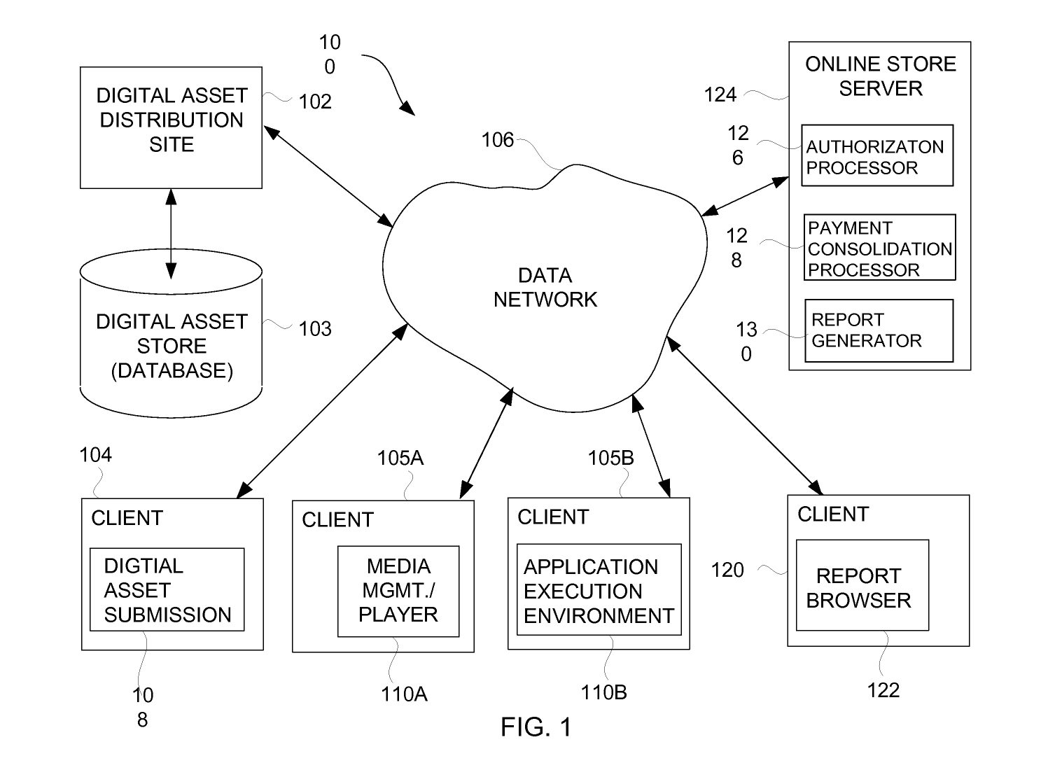

Embodiments of the invention are discussed below with reference to FIGS. 1-7. However, those skilled in the art will readily appreciate that the detailed description given herein with respect to these figures is for explanatory purposes, as the invention extends beyond these limited embodiments.

FIG. 1 is a block diagram of a digital asset submission and distribution system 100 according to one embodiment. The system 100 may include a digital asset distribution site 102. The digital asset distribution site 102 may coordinate submission (receipt), storage and purchase of digital assets. The digital assets may comprise media content, such as e-book items, audio items (e.g., audio files, including music or songs), or videos (e.g., movies or recorded television programs). Further, the digital assets may comprise application programs.

The digital asset distribution site 102 may store digital assets in a data store 103. In one embodiment, the data store 103 may be a database. The data store 103 may provide mass storage of the numerous digital assets that are available for purchase. Once purchased, the digital assets may be accessed from the data store 103 over a data network 106 by way of the digital asset distribution site 102.

The digital asset submission and distribution system 100 may also include a first client 104, second clients 105A, 1058 and a third client 120. Typically, the system 100 may include a plurality of different clients 104, 105A, 1058, 120. The first client 104 may include a digital asset submission program 108. The second clients 105A, 1058 may include a media management/player 110A and an application program execution environment 1108. The third client may include a report browser 122, which may be an online report browser. Some clients may also include any combinations of the digital asset submission program 108, the media management/player 110A, the application program execution environment 1108 and the report browser 122.

The digital asset submission program 108 may be an application program (e.g., software application) that operates on the first client 104, which may be a computing device. Examples of digital asset submission programs may include iTunes Producer™ or Label Connect™ or iTunes Connect™ offered by Apple Inc. The digital asset submission program 108 may be used by a digital asset provider to submit digital assets to the digital asset distribution site 102. Although the digital asset submission program 108 and the media management/player 110 are shown in FIG. 1 as separate programs, it should be understood that such programs may be integrated into a single program or reside on the same first client.

In the system 100 shown in FIG. 1, the digital asset provider may submit digital assets to the digital asset distribution site 102 by way of the digital asset submission program 108. The digital assets that have been submitted (e.g., via the first client 104) may be stored in the data store 103.

The media management/player 110 may be an application program (e.g., software application) that operates on the second client 105, which may be a computing device. One example of a suitable media management/player 110 may be iTunes™ offered to customers by Apple Inc. The second client 105A may be coupled to the digital asset distribution site 102 through the data network 106. Customer purchases may be handled online, using online store server 124, which may coupled to the digital asset distribution site 102, and the second client 105A through the data network 106. Further, in some embodiments, any of the first clients 104 may interact with the digital asset distribution site 102 to review, manage and/or purchase digital assets using the online store server 124.

In view of the foregoing, it should be understood that the submission and the purchase of the digital assets may be achieved over the data network 106. In other words, the submission and purchase of the digital assets can be achieved online. The purchase of digital assets using the online store server may also be referred to as electronic commerce (e-commerce). In one embodiment, the data network 106 includes at least a portion of the Internet. The clients and online store server may vary with application, but generally are computing devices that have memory storage.

Upon purchasing a particular digital asset, the digital asset distribution site 102 may permit the media content or application program of the particular digital asset to be retrieved from the data store 103 and then delivered (e.g., downloaded) from the digital asset distribution site 102 to the corresponding one of the clients 105A, 1058 through the data network 106. In this regard, the digital asset distribution site 102 may obtain the media content or application program corresponding to the particular digital asset from the data store 103 and download such media content or application program through the data network 106 to one of the clients 105A, 1058. The downloaded media content or application program of the digital asset may then be stored on one of the clients 105A, 1058. Thereafter, the media management/player 110A may present (e.g., play) the media content of the digital asset at the client 105A. Similarly, in a case where the downloaded digital asset may be an application program, the application program execution environment 1108 may execute the downloaded application program at the client 1058.

The system 100 may allow a user of the clients 105A, 1058 to browse, search or sort through a plurality of digital assets that may be purchased from the digital asset distribution site 102, and to purchase the digital asset using the online store server 124. For example, the media management/player 110A may allow the user to preview a media clip of the digital assets. In the event that the user of the media management/player 110A desires to purchase a particular digital asset, the user (via the client 105A) and the digital asset distribution site 102 may engage in an online commerce transaction using the online store server 124 in which the user pays for access rights to the particular digital asset. In one embodiment, a credit card associated with the user may be charged electronically for the purchase amount of the particular digital asset.

Further, the digital asset provider may submit at least one digital asset to the online store server 124 for electronic distribution in countries using different currencies. Accordingly, the online store server 124 may execute online store software for generating royalties currently due to the digital asset provider for online store sales of digital asset copies in the plurality of different currencies, and for accessing payment records of such payments. Similarly, the online store may include advertising with the distribution of the digital asset. An example of a contextual advertising program may include iAds™ offered by Apple Inc. Accordingly, the online store server 124 may execute online store software for generating advertising payments currently due to the digital asset provider for such advertising, and for accessing payment records of such advertising payments. In one embodiment, the payment records may be electronic records that may be managed by the online store software using the online store server 124 of the system 100.

In one embodiment, an authorization processor 126 may be implemented in software executing on the online store server 124 for providing authorization for digital asset providers. Log-in passwords and automated, interlocking file access permissions may be used to manage authorization for the digital asset providers. Such authorization of the digital asset provider may comprise authorization for online access to the online store server 124, authorization for submitting of at least one digital asset to the online store server 124 and/or authorization for accessing records of the digital asset provider's banking information and/or authorization for the accessing payment records of the royalties currently due to the digital asset provider for the online store sales in the plurality of different currencies.

Moreover, in one embodiment, a payment consolidation processor 128 may be implemented in software executing on the online store server 124, for initiating consolidation of the royalties currently due to the digital asset provider into a consolidated payment in a single currency, and for initiating disbursement of the consolidated payment. Further, the consolidation may comprise consolidation of royalties currently due to the digital asset provider for online store sales of digital asset copies with a payment currently due to the digital asset provider for advertising. The initiated consolidation and disbursement may be effected by interacting with one or more financial institutions or other intermediary (not shown in FIG. 1) over the data network 106.

Additionally, in one embodiment, a report generator 130 may be implemented in software executing on the online store server 124 and accessing the payment records to report payment information. As will be discussed in greater detail subsequently herein, the reported payment information may comprise any of the following, and may comprise any combination of the following: a report of the royalties currently due to the digital asset provider in the plurality of different currencies; a report of consolidated payment information in the single currency; a report of at least one currency conversion value, wherein the currency conversion value substantially corresponds the consolidation of the royalties currently due in the plurality of currencies into the consolidated payment in the single currency; a report of the advertising payment currently due to the digital asset provider for advertising; and a report of a return of failed disbursement.

The authorization processor 126 of the online store server 124 may authorize the digital asset provider using one of the clients to receive any of the foregoing report of payment information over the data network 106, using the previously discussed authorization techniques. For example, in one embodiment the authorization processor 126 may authorize the digital asset provider to access the online store server 124 for online reporting of any of the foregoing payment information, or any combination of the foregoing payment information.

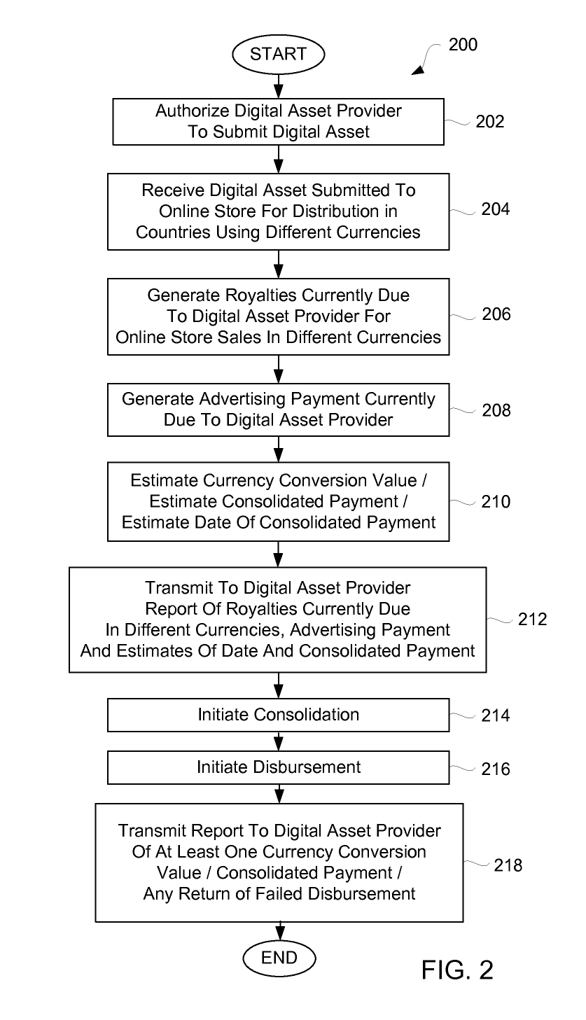

FIG. 2 is a flow diagram of a process 200 for controlling services of an online store, according to one embodiment. The process 200 may begin with authorizing 202 a digital asset provider to access the online store for submitting at least one digital asset to distribution by the online store. The process 200 may continue with receiving 204 at least one digital asset submitted to the online store for electronic distribution in countries using different currencies. In addition to the United States Dollar (USD), examples of such different currencies may include the European Union Euro (EUR), the Great Britain Pound (GBP), the Canadian Dollar (CAD), the Japanese Yen (JPY) and the Australian Dollar (AUD).

The process 200 may continue with generating 206 royalties currently due to the digital asset provider for online store sales in the plurality of different currencies. The process 200 may continue with generating 208 at least one advertising payment currently due to the digital asset provider for advertising.

As a general matter, values used in commerce for currency conversion may vary from day to day, subject to market conditions. To provide helpful reporting guidance, currency conversion may be estimated before currency conversion is performed. However, an actual value for currency conversion may not be certain until currency conversion is performed. The process 200 may continue with estimating 210 at least one currency conversion value. For helpful reporting guidance, the estimated currency conversion value may be applied to the royalties currently due to the digital asset provider for online store sales in the plurality of different currencies, and may be used to estimate the consolidated payment in the single currency. Further, an expected future date when the consolidated payment is expected or due to be paid (disbursed) to the digital asset provider may be estimated.

The process 200 may continue with transmitting 212 to the digital asset provider a report of the royalties currently due to the digital asset provider in the plurality of different currencies. The report may further comprise disclosure of the at least one advertising payment currently due to the digital asset provider. The report may further comprise disclosure of the estimated consolidated payment, and may further comprise disclosure of the estimated date for disbursement of the consolidated payment.

The process 200 may continue with initiating consolidation 214 of the royalties currently due to the digital asset provider into the consolidated payment in the single currency. Such consolidation may comprise consolidation of the royalties currently due to the digital asset provider for online store sales with at least one payment currently due to the digital asset provider for advertising. The process 200 may continue with initiating 216 disbursement of the consolidated payment. The initiated consolidation and disbursement may be effected by interacting with one or more financial institutions or other intermediary over the data network, as discussed previously herein.

The process 200 may continue with transmitting 218 a report of consolidated payment information to the digital asset provider. The report may comprise disclosure at least one currency conversion value to the digital asset provider, wherein the currency conversion value substantially corresponds to the consolidation of the royalties currently due in the plurality of currencies into the consolidated payment in the single currency. Further, it should be understood that although the disbursement of the consolidated payment may be initiated, such disbursement may fail and be returned, for example, because an electronic record used by the online store in initiating disbursement may include incorrect banking information for the digital asset provider. Accordingly, the foregoing report may comprise disclosure of the return of failed disbursement. Once the forgoing report has been transmitted to the digital asset provider, the process 200 can then end.

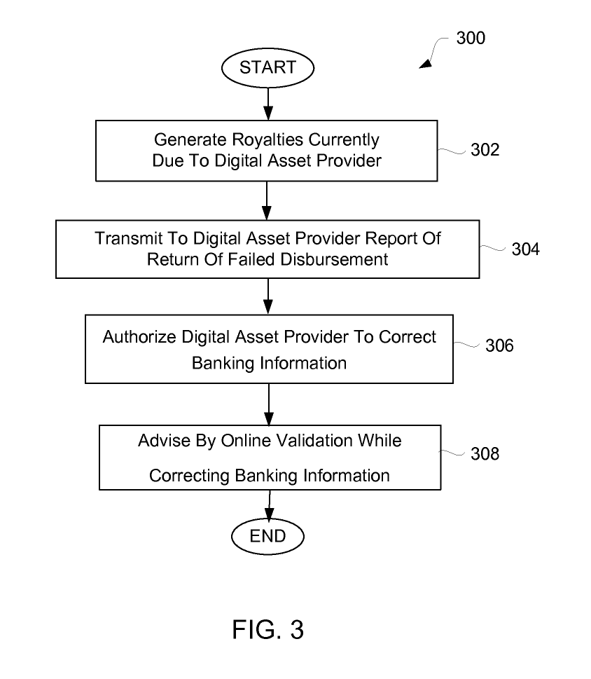

FIG. 3 is a flow diagram of another process 300, according to one embodiment. The process 300 may begin with generating 302 royalties currently due to the digital asset provider. The process may continue with transmitting to the digital asset provider a report of a return of failed disbursement. The process 300 may continue with authorizing 304 the digital asset provider to correct at least one record of incorrect banking information, which is at least one cause of the failed disbursement.

Log-in passwords and automated, interlocking file access permissions may be used to manage authorization for the digital asset provider, as discussed previously herein. Such authorization of the digital asset provider may comprise authorization for online access to the online store or any other needed authorization for accessing records of the digital asset provider's banking information, and for correcting any incorrect banking information. The incorrect banking information may comprise at least one of: an incorrect bank name, an incorrect bank address; an incorrect local clearing code; an incorrect SWIFT code; an incorrect IBAN; an incorrect account number; and incorrect account holders name; an incorrect checking account designation; an incorrect savings account designation; and an incorrect country currency designation.

The process 300 may continue with advising 308 the digital asset provider, while correcting the at least one record of the incorrect banking information, by online validation of at least one of: bank address; clearing code format; SWIFT code format; IBAN format; account number format; account holders name; checking account designation; savings account designation; and country currency designation.

Format validation may be done online by software comparison to one or more stored templates of correct format. Remaining validation may be done online by software querying financial institutions or correct records for comparison, or by software transmitting for display to the digital asset provider menu options of selectable valid choices for any of the foregoing. The software may transmit messages, for display to the digital asset provider, advising of validity or invalidity of any corrections made to the record of the digital asset provider's banking information. Once the digital asset provider has been advised while correcting banking information, the process 300 can then end.

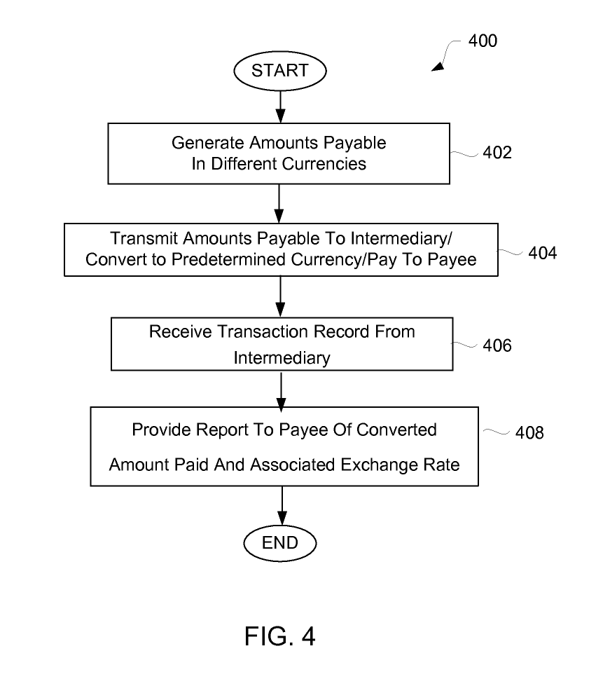

FIG. 4 is a flow diagram of another process 400, according to another embodiment. All of the following may be implemented by computer. The process 400 may begin with generating 402 amounts payable to a payee, the amounts payable in different currencies. The process 400 may continue with transmitting 404 the amounts payable to an intermediary, wherein the amounts payable are converted to one or more predetermined currencies, and paid to the payee. The process 400 may continue with receiving 406 from the intermediary a transaction record indicating the converted amount and an associated exchange rate. The process 400 may continue with providing 408 a report to the payee of the converted amount paid, and associated exchange rate. Once the report has been provided, the process 400 can then end.

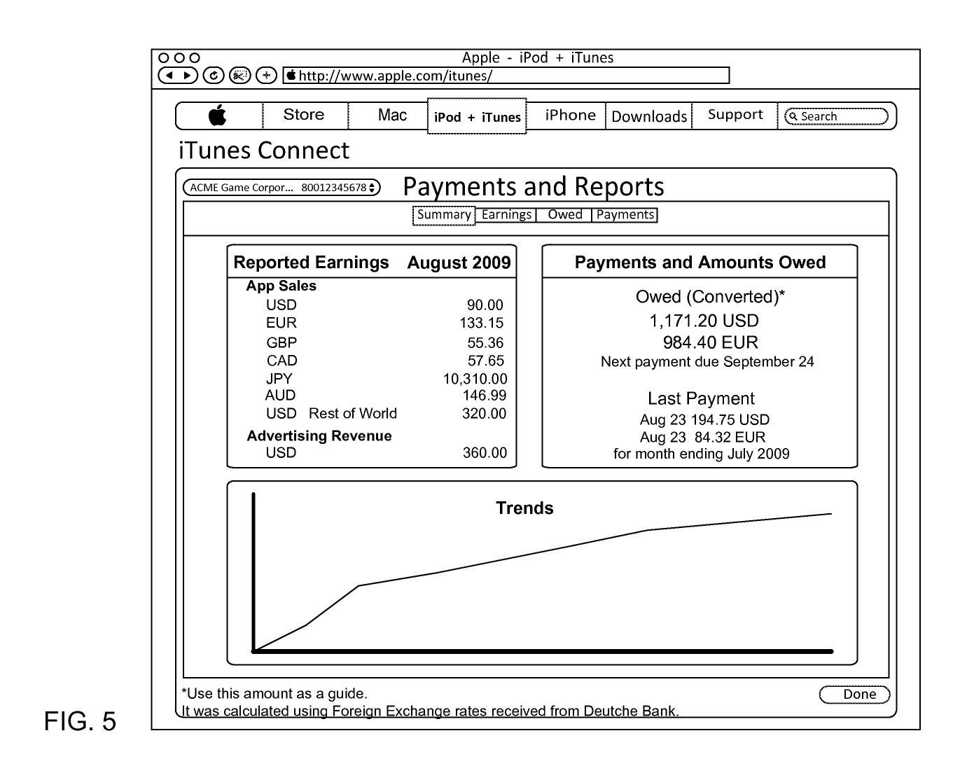

FIGS. 5-7 show report displays, illustrating one embodiment. Such reports may be generated using the report generator, and displayed on one or more clients, for example, using the report browser, as discussed previously herein with respect to FIG. 1. The report browser may be a suitably compliant web browser, such as Safari™, which is offered to customers by Apple Inc, and which is featured in the report displays of FIGS. 5-7. The report browser may be used for logging-in to the report access authorization discussed previously herein. For illustrative purposes in identifying an example digital asset provide, a hypothetical name of “Acme Game Corporation” along with a hypothetical assigned SAP™ number “80012345678” is shown FIGS. 5-7. SAP™ software may be used as a software framework to support the software discussed previously and subsequently herein.

As shown in FIG. 5, a selectable “Summary” option button of the report browser may be selected for displaying summary information, such as royalties currently due to the digital asset provider (Acme Game Corporation) for online store sales of its application program (App Sales) in the plurality of different currencies. Shown in FIG. 5 are currently due royalties in United States Dollar (USD), European Union Euro (EUR), the Great Britain Pound (GBP), the Canadian Dollar (CAD), the Japanese Yen (JPY) and the Australian Dollar (AUD). Also shown in FIG. 5 is an advertising payment 360.00 USD, which is currently due to the digital asset provider for advertising.

As discussed previously herein, an actual value for currency conversion may not be certain until currency conversion is performed. For what is displayed in FIG. 5, currency conversion values are estimated. For helpful reporting guidance in FIG. 5, estimated currency conversion values may be applied to the royalties currently due to the digital asset provider for online store sales in the plurality of different currencies, and may be used to estimate the consolidated payment in the single currency. As shown in FIG. 5, the estimate of the consolidated payment in the single currency is estimated as 1,171.20 USD. The asterisk * and corresponding statement in FIG. 5 advise the digital asset provider: “Use this amount as a guide. It was calculated using Foreign Exchange rates received from Deutche Bank.” For convenience, FIG. 5 also shows what the estimate of the consolidated payment would be in Euros. The report displayed in FIG. 5 also discloses September 23^{rd} as being the estimated date for disbursement of the consolidated payment.

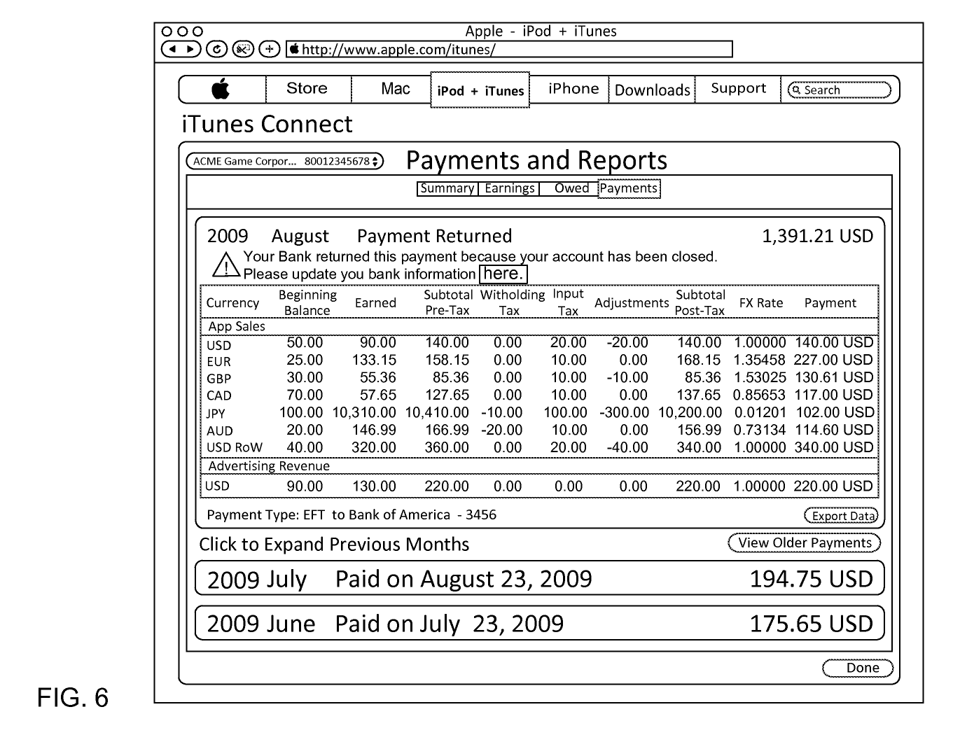

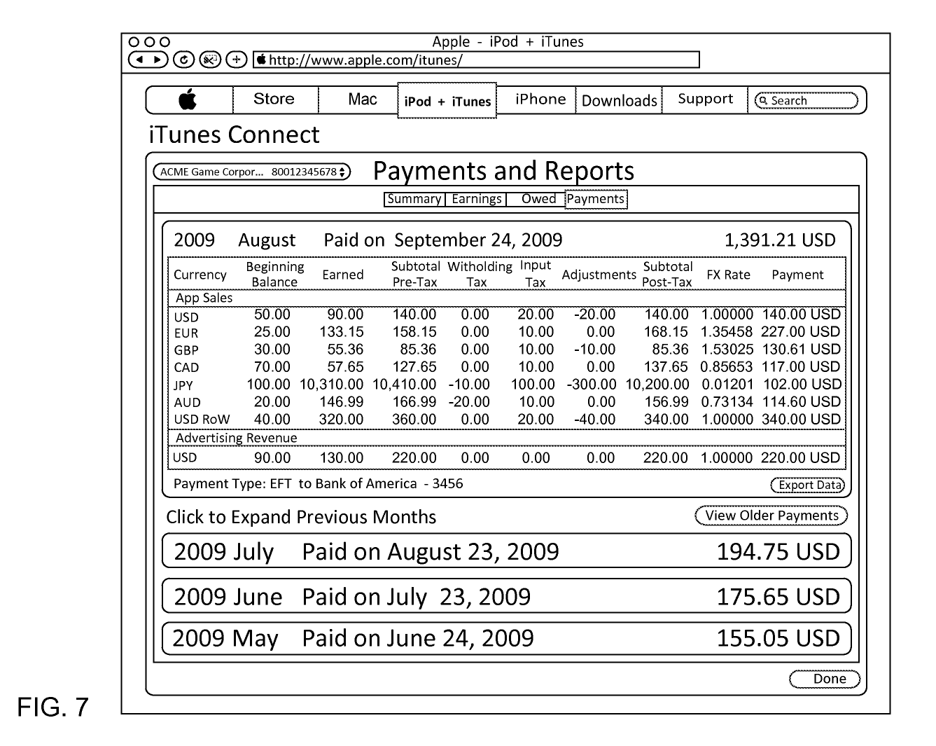

As shown in FIGS. 6 and 7, a selectable “Payments” option button of the report browser may be selected for displaying payment information. In FIG. 6 the digital asset provider is advised of a return of failed disbursement for the August 2009 payment. Accordingly, text is displayed in FIG. 6: “Your Bank returned this payment because your account has been closed. Please update you bank information here.” Further a selectable hyperlinked “here.” option button of the report browser may be selected to facilitate the digital asset provider in correcting the incorrect record of bank information online.

FIG. 7 shows display of a report of consolidated payment information to the digital asset provider. In the case of FIG. 7 the consolidated payment in the single currency is shown as 1,391.21 USD. Also shown are currency conversion values (“FX Rate”.) The currency conversion values substantially correspond to the consolidation of the royalties currently due in the plurality of currencies into the consolidated payment in the single currency.

The invention is preferably implemented by software, but can also be implemented in hardware or a combination of hardware and software. The invention can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, DVDs, magnetic tape, and optical data storage devices.

The advantages of the invention are numerous. Different aspects, embodiments or implementations may yield one or more of the following advantages. One advantage of the invention may be that the consolidated payment in the single currency may provide savings in wire transfer fees, relative to an alternative, wherein multiple wire transfers would be done (and multiple wire transfer fees would be charged) into accounts in the differing currencies. Another advantage may be that payees may perceive reporting as transparent, convenient, intuitive or user-friendly, particularly with regard to the reporting of the currency exchange rates, which are used for the consolidated payment in the single currency. Another advantage of the invention may be that online reporting of returned payments, and online validation of corrections to banking information may likewise be perceived by payees as convenient, intuitive or user-friend.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for controlling services of an online store, the method comprising:
generating royalties currently due to a digital asset provider for online store sales in a plurality of different currencies;
initiating consolidation of the royalties currently due to the digital asset provider into a consolidated payment in a single currency; and
initiating disbursement of the consolidated payment.

2. A method as recited in claim 1 further comprising receiving at least one digital asset submitted to the online store for electronic distribution in countries using different currencies.

3. A method as recited in claim 2 wherein the digital asset comprises media content.

4. A method as recited in claim 2 wherein the digital asset comprises an application program.

5. A method as recited in claim 1 further comprising authorizing the digital asset provider to access the online store for submitting at least one digital asset to distribution by the online store.

6. A method as recited in claim 1 further comprising transmitting to the digital asset provider a report of the royalties currently due to the digital asset provider in the plurality of different currencies.

7. A method as recited in claim 1 further comprising transmitting a report of consolidated payment information to the digital asset provider.

8. A method as recited in claim 1 further comprising:
using an estimate of at least one currency conversion value to generate an estimate of the consolidated payment in the single currency; and
transmitting a report of the estimate of the consolidated payment in the single currency to the digital asset provider.

9. A method as recited in claim 1 further comprising transmitting to the digital asset provider a report of an estimate of the date for the disbursement of the consolidated payment.

10. A method as recited in claim 1 further comprising transmitting a report of at least one currency conversion value to the digital asset provider, wherein the currency conversion value substantially corresponds to the consolidation of the royalties currently due in the plurality of currencies into the consolidated payment in the single currency.

11. A method as recited in claim 1 wherein the consolidation comprises consolidation of royalties currently due to the digital asset provider for online store sales with at least one payment currently due to the digital asset provider for advertising.

12. A method as recited in claim 1 further comprising transmitting to the digital asset provider a report of at least one payment currently due to the digital asset provider for advertising.

13. A method as recited in claim 1 further comprising transmitting to the digital asset provider a report of a return of failed disbursement.

14. A computer readable medium including at least computer program code stored thereon for providing a consolidated royalty for sales of digital assets via at least one online store, said computer readable medium comprising:
computer program code for generating royalties currently due to a digital asset provider for online store sales in a plurality of different currencies;
computer program code for initiating consolidation of the royalties currently due to the digital asset provider into a consolidated payment in a single currency; and
computer program code for initiating disbursement of the consolidated payment.

15. A computer readable medium as recited in claim 14 wherein the consolidation comprises consolidation of royalties currently due for online store sales with at least one payment currently due for advertising.

16. A computer readable medium as recited in claim 14 further comprising computer program code for reporting of the royalties currently due to the digital asset provider in the plurality of different currencies.

17. A computer readable medium as recited in claim 14 further comprising computer program code for reporting consolidated payment information.

18. A computer readable medium as recited in claim 14 further comprising computer program code for reporting at least one currency conversion value, wherein the currency conversion value substantially corresponds to the consolidation of the royalties currently due in the plurality of currencies into the consolidated payment in the single currency.

19. A computer-implemented method for facilitating royalty disbursement, the method comprising:
generating royalties currently due to a digital asset provider;
transmitting to the digital asset provider a report of a return of failed disbursement; and
authorizing the digital asset provider to correct at least one record of incorrect banking information, which is at least one cause of the failed disbursement.

20. A method as recited in claim 19 wherein the incorrect banking information comprises at least one of: an incorrect bank name, an incorrect bank address; an incorrect local clearing code; an incorrect SWIFT code; an incorrect IBAN; an incorrect account number; and incorrect account holders name; an incorrect checking account designation; an incorrect savings account designation; and an incorrect country currency designation.

21. A method as recited in claim 19 further comprising advising the digital asset provider, while correcting the at least one record of the incorrect banking information, by online validation of at least one of: bank address; clearing code format; SWIFT code format; IBAN format; account number format; account holders name; checking account designation; savings account designation; and country currency designation.

22. A method producing a payment report, the method comprising:
generating amounts payable to a payee, the amounts payable in different currencies;
transmitting the amounts payable to an intermediary, wherein the amounts payable are converted to one or more predetermined currencies, and paid to the payee;
receiving from the intermediary a transaction record indicating the converted amount and an associated exchange rate; and
providing a report to the payee of the converted amount paid and associated exchange rate.

23. A digital asset submission and distribution system for providing a consolidated royalty for online store sales, the digital asset submission and distribution system comprising:
a digital asset storage for storing digital assets submitted to the system by digital asset providers;
an online store server for coordinating distribution of the digital assets and collection of royalties currently due to a digital asset provider for online store sales in a plurality of different currencies; and
a payment consolidation processor for initiating consolidation of the royalties currently due to the digital asset provider in the plurality of different currencies into a consolidated payment in a single currency, and initiating disbursement of the consolidated payment.

24. A digital asset submission and distribution system as recited in claim 23 further comprising an authorization processor for authorizing the digital asset provider to receive reporting of consolidated payment information.

25. A digital asset submission and distribution system as recited in claim 23 further comprising a report generator for generating a report of consolidated payment information.
